(19) United States
(12) Patent Application Publication
(10) Pub. No.: US 2021/0206989 A1
(43) Pub. Date: Jul. 8, 2021

(54) LEAD FOR PENCIL FOR WRITING, DRAWING, MARKING, PLOTTING AND/OR COLORING

(71) Applicant: Société BIC, Clichy Cedex (FR)

(72) Inventor: Julien GOUEREC, BOULOGNE SUR MER (FR)

(21) Appl. No.: 17/130,322

(22) Filed: Dec. 22, 2020

(30) Foreign Application Priority Data
Jan. 6, 2020 (EP) 20305003.4

(51) Int. Cl. C09D 13/00

(52) U.S. Cl. CPC C09D 13/00

(57) ABSTRACT

There is a polymer-based extrudable non-calcined pencil lead having a lamellar mineral filler having a lamellarity index greater than 2.8, advantageously greater than 3.5, in particular greater than 4. There is also a pencil having such a lead and the use of a lamellar mineral filler having a lamellarity index greater than 2.8 to improve the flexural resistance and/or the smoothness, and/or the vividness of a polymer-based extrudable non-calcined pencil lead.

### CROSS-REFERENCE TO A RELATED APPLICATION

The present application claims benefit from European Patent Application No. 20305003.4, filed Jan. 6, 2020, which is incorporated herein in its entirety.

### BACKGROUND OF THE DISCLOSURE

### 1. Field of the Disclosure

The present disclosure relates to a non-calcined, polymer-based pencil lead.

### 2. Description of the Prior Art

The main advantage of using a polymer-based pencil lead in a color pencil or graphite pencil, is to combine the benefits of a cost-efficient process of co-extrusion where the different layers (lead and casing, and optionally intermediate protective layer), which are polymer-based, can be assembled in one step, with good mechanical performances of the lead. For these purposes, the lead is based on a polymer as the matrix, such as ABS (acrylonitrile-butadiene-styrene), PS (polystyrene) or polyolefin. This polymer part brings resistance, especially shock resistance, to drop test (i.e. when pencil falls on the floor), avoid the formation of cracks on all the pencil long and prevent from split leads. Also these polymers are easily transformed with high outputs by extrusion and enable to get a consistent compound with pigments, fillers and additives dispersed inside. The drawback concerns mostly the writing/coloring experience. Indeed, contact to the paper is modified due to the polymer, being not as smooth with a rich and vivid deposit as a traditional wood case lead (calcined lead) can be. Depending on the polymer, friction coefficient on paper is high, then scratchy or sticky sensations can be perceived by the consumer who needs to apply more pressure to get an acceptable laydown.

On the contrary, traditional wood case leads (calcined or baked leads) for pencil are not based on polymer binder but on natural fillers, which have been mixed with pigments, additives and a film forming binder such as cellulosic binder, preliminarily dried, the lead being calcined or baked in the process of preparation. Then contact to the paper is not disturbed by any polymer element since it has disappeared during the calcining/baking step, coloring is smooth and glides better on paper. Color is also more vivid. The drawback of this type of lead is the shock resistance, the lead being sensitive to drop test, and breakage at sharpening. Baked/calcined leads have no more resilience to absorb mechanical stress. Then leads can be broken inside the wood core, thus being unsatisfactory for consumers. Moreover, associated process is complex and divided into 2 parts: leads preparation (blending, spinning, drying/calcining and/or baking) and wood slats preparation followed by gluing, assembling, pressing and cutting, thus being time and workforce highly consuming. Relevant wood wastes are also generated.

Therefore it would be interesting to obtain a pencil lead combining the properties of a polymer-based lead (such as cost-efficient process of co-extrusion, only one step during the process, good mechanical performances) and the properties of a traditional calcined or baked lead (such as smoothness, easiness of the deposit, vivid color laydown, smoothness on the paper).

Lamellar mineral fillers having such lamellarity index are for example known from U.S. Pat. No. 6,348,536 as functional fillers for thermoplastic material in order to increase the flexural modulus without diminishing the shock resistance.

However, it was never described nor suggested that such filler could be used in pencil lead in order to have the above mentioned properties, and in particular to have an impact on the vividness of the laydown on the paper, in particular on the vividness of the colored laydown and/or on the smoothness, or softness of the writing/coloring experience.

### SUMMARY OF THE DISCLOSURE

In particular, an objective of the present disclosure is to obtain a pencil lead having good mechanical properties, such as flexibility and/or shock resistance, and exhibit smoothness and/or softness, and/or glide of the lead and which gives a good laydown, such as quality of the deposit, intensity and/or vividness of the deposit, in particular when used on paper for coloring and/or drawing. It has been surprisingly found that it is the case when a lamellar mineral filler having a lamellarity index greater than 2.8 is used in the composition of a polymer-based pencil lead.

A first object of the present disclosure therefore concerns a polymer-based extrudable non-calcined pencil lead comprising a lamellar mineral filler having a lamellarity index greater than 2.8, more specifically greater than 3.5, and even more specifically greater than 4.

A second object of the present disclosure is a pencil comprising a lead according to the disclosure.

The lead according to the present disclosure thus belongs to the category of polymer-based lead, also referred to as synthetic lead, and it is thus non-calcined. Therefore, no calcining/baking step is used in its manufacturing method.

### DETAILED DESCRIPTION OF THE DISCLOSURE

For the purposes of the present disclosure, the term “polymer-based pencil lead” is intended to mean any pencil lead comprising at least one polymer. According to the present disclosure, the term “polymer’ means compounds (in particular large molecules or macromolecules) comprising many repeated units, in particular at least two repeating units, or more specifically at least ten repeating units. This polymer thus functions as a matrix for the production of the lead during the manufacturing method. In particular, the polymer also governs the mechanical properties, the writing quality and erasing quality in the finished product.

In an advantageous embodiment, the total polymer content of the pencil lead according to the disclosure is in the range 20-45%, more specifically 25-40%, and even more specifically 30-40%, by weight relative to the total weight of the lead.

In another embodiment, the polymer of the lead is selected from the group consisting of homo or copolymers of polyesters; homo or copolymers of polyolefins (PO) such as polyethylene, polypropylene and mixtures thereof; homo or copolymers of styrene polymers, such as polystyrene (PS), styrene-acrylonitrile copolymers (SAN), acrylonitrile-butadiene-styrene copolymers (ABS), styrene-butadiene copolymers (SB), general purpose polystyrene (GPPS), high impact polystyrene (HIPS) and mixtures thereof and mixtures thereof.

More specifically, the polymer of the lead is selected from the group consisting of homo or copolymers of styrene polymers, advantageously the homo or copolymers of styrene polymers are chosen in the group consisting of general purpose polystyrene, acrylonitrile-butadiene-styrene copolymers, styrene-butadiene copolymers and mixtures thereof, still more advantageously in the group consisting of general purpose polystyrene, acrylonitrile-butadiene-styrene copolymers and mixtures thereof, in particular it is general purpose polystyrene.

The lead according to the present disclosure is extrudable, that is to say, that it can be obtained by extrusion. More specifically, it is extruded. The lead according to the present disclosure is advantageously non-expanded. In fact, advantageously no expansion agent is used in its manufacturing method. In addition, advantageously the polymer used is not expanded.

The lead according to the present disclosure is a pencil lead, that is to say, intended to be used in pencils, in particular in pencils coated with wood or with a synthetic wood material, optionally comprising an intermediate protective layer, in particular as described in patent application WO01/43987, WO 2016/097554 and WO 2017/220914.

The lead according to the present disclosure comprises at least a lamellar mineral filler having a lamellarity index greater than 2.8, more specifically greater than 3.5, and even more specifically greater than 4.

The lamellar mineral filler has thus more specifically the form of a powder before its addition in the lead according to the disclosure.

Specifically, the lead according to the disclosure is solid at room temperature. More specifically, according to the present disclosure, the lead according to the present disclosure is not a powder (i.e. not in the shape of a powder), i.e. the lead is not in a pulverulent form. More specifically, the lead according to the disclosure is a molded and/or extruded solid composition.

To determine the “hardness” of a lead in accordance with the disclosure, the measurement of flexural strength can be measured. The flexural strength should be understood as the strength and the shock resistance of the pencil. The impact strength can be measured by Charpy impact test according to the standard NF EN ISO 179-1 of 2010.

According to one embodiment of the disclosure, the lead according to the disclosure is characterized in that the pencil flexural resistance is higher than 0.70 daN.

For the purposes of the present disclosure, the term “lamellarity index” characterizes the shape of the particle of the lamellar mineral filler, and more particularly its flatness (large dimension/thickness). In the present disclosure, this lamellarity index will be measured by the difference between, on the one hand, the value of the mean dimension of the particles of the lamellar mineral filler (D_{L50}) obtained by a particle size measurement by Malvern laser diffraction using a wet method (standard AFNOR NFX11-666) and on the other hand, the value of the mean diameter (D_{S50}) obtained by a measurement by sedimentation using a “Sedigraph” (standard AFNOR X11-683), this difference being related to the mean diameter D_{S50}.

Lammelarity index: (D_{L50}−D_{S50})/D_{S50}

Reference may be made to the article G. BAUDET and J. P. RONA, Ind. Min. Mines et Carr. Les techn. June, July 1990, pp 55-61 which shows that this index is correlated to the mean ratio of the largest dimension of the particle to its smallest dimension.

For the purposes of the present disclosure, the term “mean diameter D₅₀^{”} is intended to mean a diameter such that 50% of the particles by weight have a size less than the the diameter. For non-spherical particles, the size consists of the equivalent spherical diameter (Stocks diameter). All measurements of the diameters D₅₀ were either carried out by means of a “Sedigraph” apparatus by gravity sedimentation in accordance with standard AFNOR X11-683 (D_{S50}) or by Malvern laser diffraction using a wet method (standard AFNOR NFX11-666) (D_{L50}).

In an embodiment, the mean diameter D_{S50} of the lamellar mineral filler measured by sedimentation using a “Sedigraph” (standard AFNOR X11-683) is between 0.5 and 5 μm, more particularly between 0.5 and 4 μm, still more advantageously between 1 and 3 μm, in particular of between 1.5 and 2.5 μm.

In another embodiment, the mean diameter D_{L50} of the lamellar mineral filler measured by Malvern laser diffraction using a wet method (standard AFNOR NFX11-666) is between 2 and 30 μm, more particularly between 5 and 20 μm, still more advantageously between 7 and 15 μm.

For the purposes of the present disclosure, the term “lamellar mineral filler” is intended to mean any mineral filler or any synthetic filler of which the structure consists of a stack of elementary leaves. Advantageously the lamellar mineral filler according to the disclosure is a colorless or white lamellar mineral filler, mineral or synthetic particles of any shape, more advantageously selected in the group consisting of clay, talc, boron nitride, mica and mixtures thereof, more advantageously in the group consisting of mica, talc and mixtures thereof, still more advantageously it is talc, in particular HAR® talc such as the reference Talc Luzenac Har® T84 sold by Imerys. This talc has in particular the following properties:

D_{L50} (μm) (mean particle size diameter by laser)=10.5

D_{S50} (μm) (mean particle size diameter by sedigraph)=2

Lamellarity index: (D_{L50} D_{S50})/D_{S50}=(10.5−2)/2=4.25.

Whiteness (Minolta CR400, illuminant D65/2))Y L* (CIE)=91

Typical aspect ratio (length/thickness)=120

The lamellar mineral filler according to the disclosure can be obtained by the process as described in U.S. Pat. No. 6,348,536.

The lamellar mineral filler is specifically used in pencil lead in order to have an impact on the vividness of the laydown on the paper and/or on the smoothness or softness of the writing/drawing/coloring experience.

In an advantageous embodiment the total lamellar mineral filler content of the pencil lead according to the disclosure is in the range 5-40%, advantageously 10-25%, more advantageously 10-15%, by weight relative to the total weight of the lead.

A further object of the disclosure is the use of a lamellar mineral filler having a lamellarity index greater than 2.8 as defined previously to improve the flexural resistance and/or the smoothness, and/or the vividness of a polymer-based extrudable non-calcined pencil lead, in particular when writing/drawing/coloring on paper.

The pencil lead according to the disclosure can also contain a slip agent. Indeed slip agents are able to modify the surface properties of a film and thus lower the friction between film layers and other surfaces. To be particularly effective the slip agent needs to migrate out of the polymer to the surface and therefore it is advantageous for it to have a degree of incompatibility with the polymer.

The benefits of the use of a slip agent in the pencil lead composition are: enhance both appearance and function (to improve smoothness and glides), improve the flow characteristic of the polymer during processing.

Slip agents are effective because of their natural tendency “to bloom” to the surface of the film after extrusion. The slip agent to be used in the pencil lead according to the present disclosure is more specifically selected in the group consisting of amides such as ethylene bis stearamide, oleamide, erucamide and stearamide, glycerol derivatives such as glycerol esters such as glycerol ethylhexyl polyhydroxystearate, glycerol behenate, glycerol dibehenate, tribehin, glycerol trihydroxystearate and mixtures thereof, esters of stearic acid and more specifically tetraester of stearic acid, esters of pentaerythritol such as pentaerythrityl tetrastearate, and mixtures thereof. More specifically the slip agent is a glycerol ester, more specifically selected in the group consisting of glycerol ethylhexyl polyhydroxystearate, glycerol dibehenate and mixtures thereof.

More specifically, the total slip agent content of the pencil lead according to the present disclosure is in the range 0.5-5%, more specifically 2-4%, by weight relative to the total weight of the lead.

The pencil lead according to the present disclosure can advantageously contain at least a coloring agent.

Advantageously the coloring agent is selected in the group consisting of dyes, pigments and mixtures thereof, more advantageously in the group consisting of organic or inorganic pigments, dyes or lacquered dyes, coated mica as well as coated or uncoated metal bronzed, TiO₂, carbon black, graphite and mixture of these coloring agents. The term “pigments” should be understood as meaning white or coloured, mineral or organic particles of any form, which are insoluble in the medium, and which are intended to color the lead. The term “dyes” should be understood as meaning white or colored, mineral or organic particles of any form, which are soluble in the medium, and which are intended to color the lead. In an advantageous embodiment, the coloring agent is selected in the group consisting of pigments and mixtures thereof, still more advantageously in the group consisting of organic pigments, TiO₂ and mixtures thereof. Depending on the desired color of the lead, the pigment is a red, black, yellow, orange, blue, magenta or violet pigment, and mixtures thereof.

The pigment and/or carbon black can be coated or mixed with a polyolefin wax (for example in the form of a masterbatch, a pigmentary preparation or a dispersion of pigment in a polyolefin wax) as mentioned in WO2016/097555 and WO2016/097533. The coloring agent gives the lead color.

Specifically, the total coloring agent content of the pencil lead according to the disclosure is in the range 2-25%, more specifically 10-20%, by weight relative to the total weight of the lead.

According to this embodiment, specifically the pencil is a color pencil lead or a graphite pencil lead, more specifically a color pencil lead.

Advantageously, according to this embodiment wherein the pencil lead according to the present disclosure contains at least coloring agent (colored pencil lead), the obtained deposit (laydown) when applied on a surface, such as paper, exhibits a good intensity (or vividness) of the color. According to a preferred embodiment of the disclosure, the pencil flexural resistance is higher than 0.70 daN.

The pencil lead according to the present disclosure can contain a wax.

For the purposes of the present disclosure, the term “wax” is intended to mean a lipophilic compound, which is solid at room temperature (25° C.), with a reversible solid/liquid change of state, and having a melting point of 30° C. or more, and more specifically which may be up to 180° C.

In the present disclosure, the melting point corresponds to the transition stage between a fully crystalline or partially crystalline solid state and an amorphous liquid of variable viscosity, as described in ISO 11357-3; 2011. The term “transition”, also referred to as “fusion”, is characterized by an endothermic peak in the DSC curve.

The melting point of wax can be measured by differential scanning calorimetry (DSC) using a TA Instruments Q20 apparatus, on a temperature range from 20 to 90° C., at cooling/heating speeds of 10° C./minute.

This measurement is made with 5 mg of sample mass.

Method:

1. Equilibrate at 0° C.

2. Mark end of cycle

3. Ramp: 10° C./min to 90° C.

4. Isothermal for 2 min

5. Ramp: 10° C./min to 0° C.

6. Isothermal for 2 minutes

7. End of method

The waxes may be hydrocarbon-based waxes, lignite-waxes, amide waxes, fatty acids, fatty acid esters, and/or ester waxes, and mixtures thereof, and may be of plant, mineral, animal and/or synthetic origin.

In particular, the waxes have a melting point of greater than 30° C. and better still greater than 50° C., more specifically which may be up to 180° C.

More specifically the wax according to the disclosure is selected in the group consisting of ester waxes, chosen among stearates waxes (melting point: 120-160° C.) such as calcium stearate, lignite waxes such as montan waxes, amide waxes, hydrocarbon-based waxes such as paraffin (melting point: 50-60° C.), fatty acids such as stearic acid and palmitic acid, fatty acid esters and mixtures thereof, specifically ester waxes, more specifically stearate waxes, and more advantageously it is calcium stearate. It is indeed advantageous if the wax is formed of calcium stearate or comprises calcium stearate.

More specifically the total wax content of the pencil lead according to the disclosure is in the range 10-40%, advantageously 20-35%, by weight relative to the total weight of the lead.

The pencil lead according to the present disclosure can contain additional filler, different from the described lamellar mineral filler having a high lamellarity index, such as mineral fillers, for example chosen from phyllosilicates, chalk, barite, kaolin, bentonite and mixtures thereof. More specifically, the pencil lead according to the present disclosure does not contain any other filler than the lamellar mineral filler having a lamellarity index greater than 2.8.

The pencil lead according to the present disclosure can contain an additive. This additive can be selected from additives which are well known to the person skilled in the art in the field of pencil leads, advantageously it is selected in the group consisting of lubricants such as zinc stearate, plasticizers such as phthalate, adipate, benzoate, sebacate and/or citrate plasticizers, in particular dibenzoate, surface-active agents, thermal stabilizers and mixtures thereof.

Advantageously the total additive content of the pencil lead according to the disclosure is in the range 3-10% and more specifically 5-9%, by weight relative to the total weight of the lead.

The pencil lead according to the disclosure can be a color pencil lead or a graphite pencil lead and more specifically a color pencil lead.

In the case where the pencil lead is a graphite pencil lead, the coloring agent comprises graphite, carbon black or mixture thereof.

In a particular embodiment of the present disclosure, the pencil lead has a diameter between 2 and 3.9 mm and more specifically a lead having a diameter between 2 and 2.3 mm (thin lead) or a lead having a diameter between 3 and 3.8 mm (thick lead) or a lead having a diameter between 3.4 and 3.8 mm (very thick lead).

The lead according to the present disclosure can have a hexagonal, round or triangular cross section, advantageously a round or hexagonal cross section.

The lead according to the present disclosure can be manufactured via processes that are well known to those skilled in the art.

For example, all the components are mixed together and the mixture obtained is extruded at suitable temperatures. The lead obtained is then cooled. It is thus not calcined and/or baked.

The lead according to the present disclosure thus has sufficient color vividness while at the same time having good mechanical properties, in particular in terms of flexural strength and/or impact strength, and while producing a continuous deposit on paper with smoothness. The flexural strength should be understood as the strength and the shock resistance of the pencil. The impact strength can be measured by Charpy impact test according to the standard NF EN ISO 179-1 of 2010.

According to the disclosure, it is possible to provide a lead for writing and/or coloring, whose tensile strength and flexural strength have been improved and which also improved elasticity.

The disclosure also relates to a pencil comprising a lead according to the present disclosure, in particular a pencil coated with wood or with synthetic wood material, comprising optionally an intermediate protective layer, for example, as described in patent applications WO 01/43987, WO 2016/097554 and WO 2017/220914.

The pencil according to the disclosure can be a color pencil or a graphite pencil and more specifically a color pencil.

Advantageously, the pencil according to the disclosure is obtained by coextrusion of the lead and of the synthetic wood material and optionally of the intermediate protective layer.

In particular, the synthetic wood material is based on styrene polymer, and the intermediate protective layer can also plays the role of adhesion layer if the lead comprises a polyolefin polymer and advantageously the intermediate protective layer can comprise a mixture of EVA and of polystyrene as described in WO 2016/097554 or an ethylene (C1-C4 alkyl) acrylate copolymer, alone or as a blend with a styrene polymer as described in WO2017/220914.

Advantageously, the synthetic wood material is expanded so as to have a density equivalent to natural wood.

In a particular embodiment of the present disclosure, the pencil according to the disclosure comprises an additional decorative layer, advantageously of varnish, surrounding the synthetic wood material, in particular concentrically. Advantageously, the decorative layer is made of a material that is compatible with that of the synthetic wood material.

Advantageously, the pencil according to the present disclosure can have a hexagonal, round or triangular cross section, advantageously a round or hexagonal cross section.

Advantageously, it can comprise a means for erasing, such as an eraser, at the unsharpened end of the pencil.

The disclosure finally concerns the use of a lamellar mineral filler having a lamellarity index greater than 2.8 as defined above to improve the flexural resistance and/or the smoothness, and/or the vividness of a polymer-based extrudable non-calcined pencil lead.

The expression “between . . . and . . . ” or “ranging from . . . to . . . ” should be understood as including the values of the limits.

The disclosure will be understood better upon reading the description of the following examples which are given as a non-limiting indication.

### Examples

Examples of compositions of pencil lead according to the present disclosure (examples 1, 2, 3 and 4) containing a mineral lamellar filler having a lamellarity index of 4.25 (Talc Luzenac Har® T84) were compared with comparative compositions of pencil lead (comparative examples 1 and 2) wherein the high lamellarity mineral filler has been replaced by a mineral filler with a lamellarity index of lower than 2.8 (Luzenac 20M0 talc having the following properties: D_{L50} (μm) (particle size by laser)=10.5; D_{S50} (μm) (particle size by sedigraph)=5; Lamellarity index: (D_{L50}−D_{S50})/D_{S50}=(10.5−5)/5=1.1).

The pencil leads are produced by carrying out the steps detailed below:

Mixing and granulating all formulation components of the lead to form a writing substance granulate;

Extruding the writing substance granulate at a temperature in the range of 130 to 200° C. on an extruder by a suitable mouthpiece to form endless writing substance strands;

Cooling and hardening the endless writing substance strand; and

Cutting the endless writing substance strand to final lengths, in particular to the required pencil length.

The properties of color vividness (ΔC) and Pencil Flexural resistance (Flexion (daN)) of the leads were measured as follow:

Pencil Flexural Resistance:

The pencil flexural resistance test was carried out in order to check the strength and the shock resistance of the pencil.

The characteristics of the test were as follows:

Equipment: Dynamometer LLOYD-AMETEK Instrument type, U-bracket span of 6 cm, Sensor ADAMEL DY20 Chatillon Instrument type TCD110 50 daN

Descent speed of sensor: 50 mm·min⁻¹

Operating Method:

1. Turn on the dynamometer.

2. Locate the sensor in the up position.

3. Fix the pencil on the U-bracket.

4. Go down the needle.

5. Record the results expressed in daN.

Colorimetry:

The test protocol is as follows:

Equipment:
Writing apparatus HUTT HST 10 or equivalent used under the following conditions:
   Writing speed: 4.5 m/min
   Writing angle: 70°
   Other parameters: refer to table below
Iso paper: AURORA ISO-14145
Apparatus KONICA MINOLTA model CM-3610 A
Pencil sharpener
Viewing angle of light: 10′

TABLE 1

| | Parameters for producing the rubbings |
|---|---|
| Article type | Lead |
| Diameter lead (mm) | 2.14 |
| Paper feed (mm/min) | 0.15 |
| Total weight article/ | 175 |
| support/additional weight (g) | |
| Writing length for axial | 9 |
| rotation of the article (m) | |
| Writing length (m) | 40 |
| Paper type | AURORA ISO-14145 |

Operating Procedure:
1) Prepare the writing article in the appropriate supports, sharpen the lead if necessary.
2) Produce the rubbings according to the parameters indicated in the preceding table
3) Measure the density of the color of the rubbing with the help of the spectroEye (minimum 2 measurements per blackness) according to DIN 16536 NB

Protocol of measurement of the density of the color of the rubbing with the help of the spectroEye (minimum 2 measurements per blackness) according to DIN 16536 NB:

ΔE=/\sqrt{(L*−L*₀)²+(a*−a*₀)²+(b*−b*₀)²}

To determine the “vividness” of a lead in accordance with the disclosure, the measurement of colorimetry can be measured. The “vividness” should be understood as the intensity of the deposit i.e. laydown of the pencil when applied on a surface. The vividness can be measured by colorimetry test by measuring the color difference ΔC between a sample color and a comparative color.

The density of the color of the deposit has been measured in the CIE L*a*b* system using a KONICA MINOLTA CM-3610 A model spectrocolorimeter in the CIE L a b system (illuminant: D65, angle 10°, specular components included).

According to this system, L* indicates the lightness of the color of the deposit. The lowest is the value of L, the most intense (or “darker”) is the color of the deposit. The chromaticity coordinates are expressed by the parameters a* and b*, a* indicating the axis of red/green shades and b* the axis of yellow/blue shades. The chromaticity C* is obtained from the following formula.

C*_{ab}=\sqrt{a*²+b*²}

All colorimetric measurements have been done on a deposit made on a white paper. The greater the value of C* (also called C*_{ab}), the better the saturation of the color of the deposit.

The composition (in weight %) and results are indicated in tables 2 and 3 below:

TABLE 2
polymer = GPPS

| | | | | | Comparative |
|---|---|---|---|---|---|
| | Trade name | Example 1 | Example 2 | Example 3 | example 1 |
| Polymer | GPPS | 36% | 33% | 33% | 36% |
| Lamellar mineral | Talc Luzenac | 14% | 14% | 14% | 0% |
| filler | Har ® T84 | | | | |
| Mineral filler | Talc 20 Mo | 0% | 0% | 0% | 14% |
| Wax | Calcium stearate | 26% | 26% | 26% | 26% |
| Coloring agent | Organic pigment | 7.75% | 7.75% | 7.75% | 7.75% |
| Coloring agent | TiO₂ | 7.75% | 7.75% | 7.75% | 7.75% |
| Additive Plasticizer | Dibenzoate | 6% | 6% | 6% | 6% |
| Additive Lubricant | Zinc stearate | 2.5% | 2.5% | 2.5% | 2.5% |
| Slip agent | Glycerol ethylhexyl | 0% | 3% | 0% | 0% |
| | polyhydroxystearate | | | | |
| Slip agent | Glycerol dibehenate | 0% | 0% | 3% | 0% |
| Total | | 100% | 100% | 100% | 100% |
| Flexion (daN) | | 0.852 | 0.889 | 0.765 | 0.755 |
| C* | | 18.98 | 20.35 | 19.53 | 17.15 |

TABLE 3
polymer = ABS

| | | | Comparative |
|---|---|---|---|
| | Trade name | Example 4 | example 2 |
| Bonding agent | ABS | 36% | 36% |
| Mineral filler | Talc 20MO | 0% | 14% |
| Lamellar mineral | Talc Luzenac | 14% | 0% |
| filler | Har ® T84 | | |
| Wax | Calcium stearate | 26% | 26% |
| Coloring agent | Organic pigment | 7.75% | 7.75% |
| | TiO2 | 7.75% | 7.75% |
| Additive Plasticizer | Dibenzoate | 6% | 6% |
| Additive Lubricant | Zinc stearate | 2.5% | 2.5% |
| Slip agent | Glycerol ethylhexyl | 0% | 0% |
| | polyhydroxystearate | | |
| Total | | 100% | 100% |
| Flexion (daN) | | 0.940 | 0.920 |
| C* | | 19.59 | 18.75 |

As a consequence, the leads of examples 1, 2, 3 and 4 according to the disclosure which comprise a high lamellarity mineral filler have enhanced flexural properties and color vividness compared to the leads of comparative examples 1 and 2 wherein the high lamellarity mineral filler has been replaced by a low lamellarity mineral filler.

In addition, the smoothness, the glide as well as the softness of the lead has been evaluated by writing, drawing and/or coloring manually with the leads according to examples 1 to 4 and it has been observed that they deliver an effortless and smooth-gliding writing, drawing and/or coloring experience on paper.

1. A polymer-based extrudable non-calcined pencil lead comprising a lamellar mineral filler having a lamellarity index greater than 2.8.

2. The pencil lead according to claim 1, wherein the lamellar mineral filler is talc.

3. The pencil lead according to claim 1, wherein the total content of lamellar mineral filler is in the range 5-40% by weight relative to the total weight of the lead.

4. The pencil lead according to claim 1, wherein the polymer is selected from the group consisting of homo or copolymers of polyesters; homo or copolymers of polyolefins such as polyethylene, polypropylene and mixtures thereof; homo or copolymers of styrene polymers, such as polystyrene, styrene-acrylonitrile copolymers, acrylonitrile-butadiene-styrene copolymers, styrene-butadiene copolymers, general purpose polystyrene, high impact polystyrene and mixtures thereof.

5. The pencil lead according to claim 4, wherein the polymer is selected from the group consisting of homo and copolymers of styrene polymers.

6. The pencil lead according to claim 1, wherein the total polymer content is in the range 20-45% by weight relative to the total weight of the lead.

7. The pencil lead according to claim 1, further comprising a slip agent.

8. The pencil lead according to claim 7, wherein the total slip agent content is in the range 0.5-5%.

9. The pencil lead according to claim 1, further comprising a coloring agent.

10. The pencil lead according to claim 9, wherein the total content of coloring agent is in the range 2-25%.

11. The pencil lead according to claim 1, further comprising a wax.

12. The pencil lead according to claim 11, wherein the total wax content is in the range 10-40%.

13. The pencil lead according to claim 1, further comprising an additive.

14. The pencil lead according to claim 13, wherein the total additive content is in the range 3-10%.

15. The pencil lead according to claim 1, wherein the pencil lead is a color pencil lead or a graphite pencil lead.

16. The pencil lead according to claim 1, wherein the pencil lead is an extruded pencil lead.

17. A pencil comprising a lead as claimed in claim 1.

18. A method of improving the flexural resistance and/or the smoothness, and/or the vividness of a polymer-based extrudable non-calcined pencil lead, comprising incorporating into the pencil lead the lamellar mineral filler of claim 1.

19. The pencil lead according to claim 5, wherein the polymer is selected from the group consisting of general purpose polystyrene, acrylonitrile-butadiene-styrene copolymers and mixtures thereof, in particular it is general purpose polystyrene.

20. The pencil lead according to claim 1, wherein the lamellarity index is greater than 4.
